(19) United States
(12) Patent Application Publication
(10) Pub. No.: US 2010/0287857 A1
(43) Pub. Date: Nov. 18, 2010

(54) DOOR FRAMING SYSTEM

(76) Inventor: Ian Kerr, Peterborough (CA)

Correspondence Address: SIM & MCBURNEY, 330 UNIVERSITY AVENUE, 6TH FLOOR, TORONTO, ON, M5G 1R7, CA

(21) Appl. No.: 12/780,545

(22) Filed: May 14, 2010

Related U.S. Application Data
(60) Provisional application No. 61/178,209, filed on May 14, 2009.

(51) Int. Cl. E06B 1/04

(52) U.S. Cl. 52/211

(57) ABSTRACT

A door framing system includes a header including a header jamb, first and second legs each including a leg jamb dimensioned to abut against and extend downwards from a respective end of the header jamb, and, for each leg jamb, at least one adjustable connector for establishing a connection between the leg jamb and the header jamb and permitting selective tightening or loosening of the connection.

### CROSS REFERENCE TO RELATED APPLICATION

This application claims priority under 35 U.S.C. 119(e) from U.S. Provisional Patent Application Ser. No. 61/178,209 filed on May 14, 2009, the contents of which are entirely incorporated herein by reference.

### FIELD OF THE INVENTION

This invention relates to building construction and renovation, and particularly to a door framing system and method.

### BACKGROUND OF THE INVENTION

Construction or renovation projects often involve the framing of doors. Door frames are conventionally constructed at the site construction in a “roughed-in” door opening. There are several challenges to on-site construction of a door frame. For example, proper construction of a door frame requires some precision to ensure the door is supported within the door frame, and to ensure that the door both swings open and closes smoothly without unduly interfering with the door frame or surrounding objects such as the floorboards. For the average homeowner, who is typically without particular door hanging skill or experience, hanging a door can be somewhat difficult and frustrating work because of the time and effort required. Therefore, the homeowner often defers the project to another person, such as a tradesperson, who has the skills and experience. Even for a professional, however, hanging a door can be time-consuming.

Prefabricated door frames have been provided by manufacturers in an attempt to mitigate these problems. However, factory-assembled prefabricated door frames have proven to be difficult to work with, due to their inherent size and fragility. Furthermore, a prefabricated door frame still requires the exercise of skill for fitting the prefabricated door frame in the roughed-in door opening, and it is required to install door trim pieces after the installation of the prefabricated door frame.

In order to mitigate some disadvantages of the prefabricated door frames, partially-assembled prefabricated door frames have been provided. However, partially-assembled prefabricated door frames also require the exercise of skill, and installation can be slow.

It is generally known that prefabricated systems such as those described above can be problematic due to bending, cracking or warping of the wood. For example, known systems generally include a doorstop attached to the frame, in the finished state. If the door frame bends or warps prior to or during installation, or if the door frame is not exactly level, the door might not rest against the doorstop when the door kin the closed position. For example, the bottom of the door may hit the doorstop while the top of the door is still spaced from the doorstop, or vice versa. This can also cause the door to bind in the frame.

Canadian Patent No. 2,035,521 to Critch describes a prefabricated floating door frame that includes slots in the header of the frame, into which the leg jambs are inserted. The leg jambs are cut at the top in a reciprocating rabbet joint, for fitting into a respective slot. While this system mitigates some of the problems of the prior art, it suffers from other disadvantages. For example, the precut jambs of these doorframes are generally constructed of a medium density fiberboard (MDF) that is about ½ inch thick, and the casing cut and the slot cut in the header jamb are at the same longitudinal spacing along the header. As such, the slot in the header jamb is a weak point in the door frame that is susceptible to breaking. Therefore, during installation, when the header is first being installed prior to the legs, should the legs not be inserted properly, or the wall studs be warped, the installer risks breaking the angled cut (forty-five degree cut) of the header casing. Also, because the door is placed into the frame when the frame is not yet fastened, and the header is then used to pull or push the top of the door and frame to a level position, breaking of the header jamb at the slot can occur.

Known prefabricated door frame systems such as those described above tend to suffer from additional disadvantages. For example, the connections between the various components of the door frame may become loosened over time from changes in the properties of the components due to moisture, temperature and/or mechanical disruption. Correction of the loosening in order to improve the door frame aesthetics and/or ensure the door swings freely between the closed and open positions typically requires a significant amount effort to reconfigure the various components with respect to each other.

Accordingly, it is an object of an aspect of the present invention to provide a door framing system that obviates or mitigates at least some of the disadvantages of the prior art discussed above.

### SUMMARY OF THE INVENTION

In accordance with an aspect of the invention, there is provided a door framing system comprising:

a header comprising a header jamb;

first and second legs each comprising a leg jamb dimensioned to abut against and extend downwards from a respective end of the header jamb; and

for each leg jamb, at least one adjustable connector for establishing a connection between the leg jamb and the header jamb and permitting selective tightening or loosening of the connection.

These together with other aspects and advantages, which will be subsequently apparent, reside in the details of construction and operation as more fully hereinafter described and claimed.

### BRIEF DESCRIPTION OF THE DRAWINGS

The invention is to be understood with reference to the drawings, and the following description, in which:

FIG. 1 is a perspective view of a door framing system, in assembled state, according to an embodiment;

FIG. 2 is a perspective view of the door framing system in unassembled state but with door stop components affixed;

FIG. 3a is an enlarged view of a portion of the door framing system;

FIG. 3b is a perspective enlarged view of a fastening cam;

FIG. 4 is a perspective view of a portion of a door framing system according to an alternative embodiment;

FIG. 5 is a perspective view of a leg of the door framing system of FIG. 4;

FIG. 6 is a perspective view of a door; and

FIG. 7 shows an enlarged portion of the door.

### DETAILED DESCRIPTION OF THE PREFERRED EMBODIMENTS

The reader may wish to refer to the Wood Door Jamb System shown in Canadian Patent Application No. 2,381,466 and the Prefabricated Door Frame and Door system as shown in U.S. Pat. No. 7,104,016. The contents of these documents are incorporated herein by reference in their entirety.

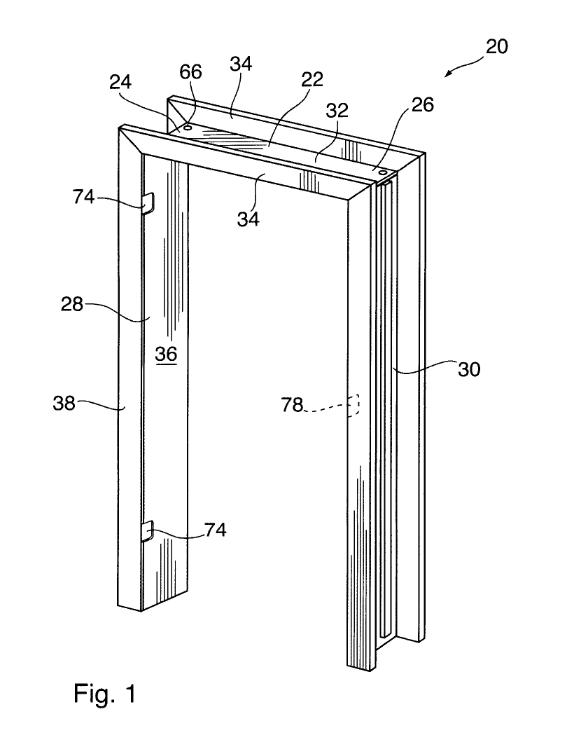

FIG. 1 shows an embodiment of an assembled door framing system 20. The door framing system 20 includes a header 22 having a first end 24 and a second end 26. A first leg 28 of the door framing system is connected to and extends downwards from the first end 24 of header 22, and a second leg 30 is connected to and extends downwards from the second end 26 of the header 22.

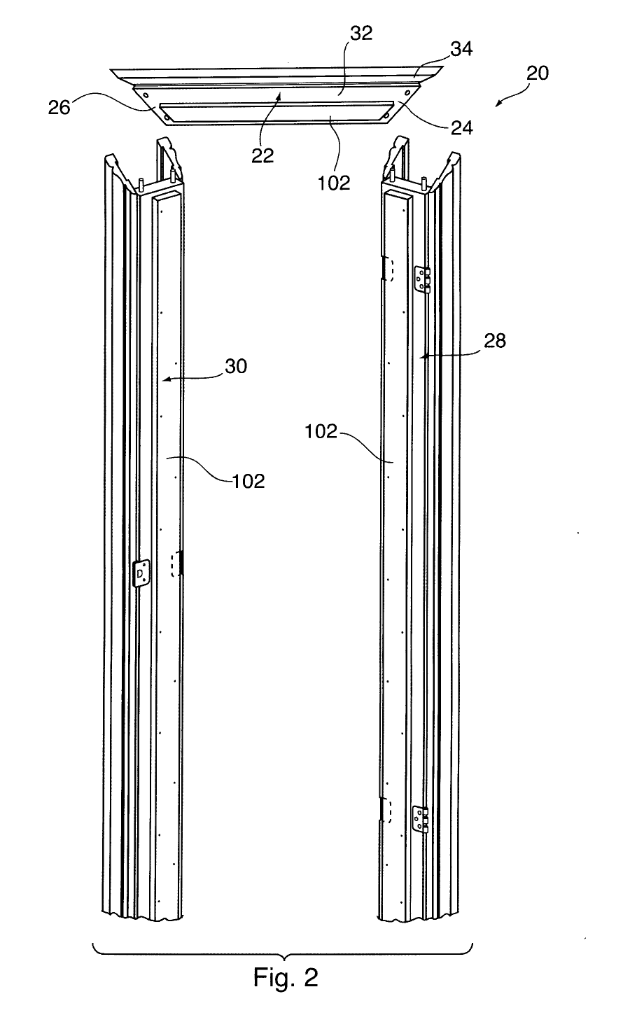

A more detailed view of the door framing system 20 may be seen in FIG. 2, which depicts the door framing system 20 in its unassembled state. As shown, header 22, which in this embodiment is formed at least partly of medium density fiberboard (MDF), includes a header jamb 32 and a pair of header casings 34. Only one of the header casings 34 is shown in FIG. 2. Each of the header casings 34 is attached to a respective side of the header jamb 32 with wood staples and/or wood glue, and extends along the length of the header jamb 32.

The first leg 28, which in this embodiment is also formed at least partly of MDF, includes a leg jamb 36 and a pair of leg casings 38. Each leg casing 38 is attached to a respective side of the leg jamb 36, and extends along the length of the leg jamb 36. It will be appreciated that when the door frame system 20 is assembled, the first leg 28 and the second leg 30 are each in an abutting relationship with their corresponding ends 24, 26 of the header 22, and extend downwards from the header 22.

As will be described, adjustable connectors, or “fasteners”, are provided to establish a connection between each leg 28, 30 and the header 22 by establishing a connection between the leg jambs 36 and the header jamb 32. The adjustable connectors permit selective tightening or loosening of the connection by a person installing or adjusting the door framing system 20. The adjustable connectors also permit disconnection of the legs 28, 30 from the header 22 as required.

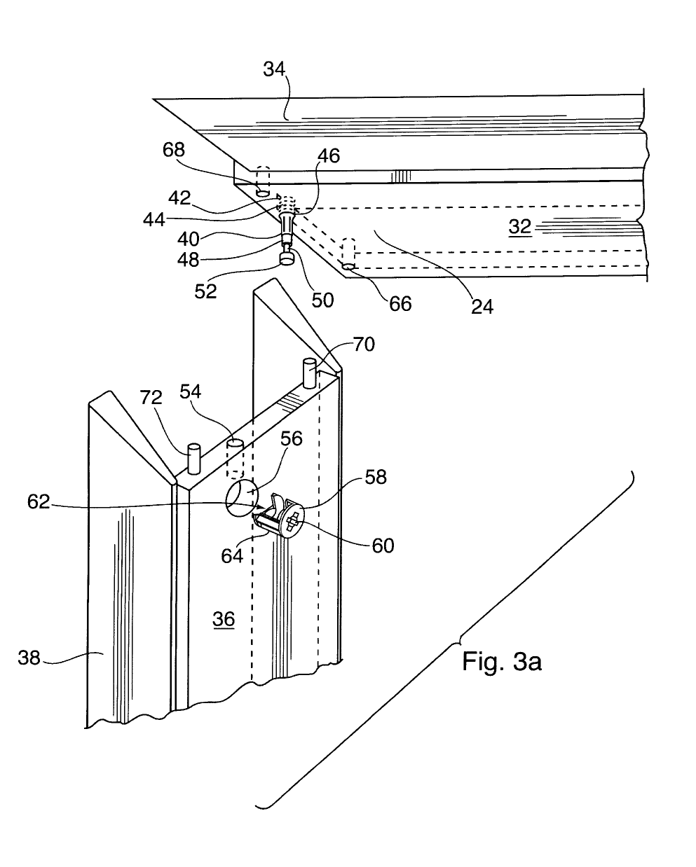

FIG. 3a shows an enlarged view of a portion of the door framing system 20, including the first end 24 of the header 22 and a portion of an end of the first leg 28. An adjustable connector is also shown, that includes a fastening post 40 and a fastening cam 58. The fastening post 40 is secured towards the first end 24 of the header jamb 32. The fastening post 40 has a first portion 42 that, in this embodiment, is threaded for screwing the first portion 42 into a fastening bore 44 at the first end 24 of the header jamb 32. The fastening post 40 also includes a shoulder 46 for restricting the depth of penetration of the first portion 42 into the header jamb 32, and a second portion 48 that extends away from the header jamb 32 when the first portion 42 is secured to the header jamb 32. The second portion 48 is elongated and comprises a substantially annular groove 50 defining a head 52.

A cam bore 54 extends into the leg jamb 36 from its end, and is positioned in the end to align axially with the fastening bore 44 so as to receive the second portion 48 of the fastening post 40 when affixed to the header jamb 32 in the fastening bore 44. The cam bore 54 extending into the leg jamb 36 opens into a side wall of a cylindrical cam recess 56. The cam recess 56 receives the generally cylindrical, or wheel-like, fastening cam 58 that can be inserted through a side surface of the leg jamb 36, as shown in FIG. 3a.

The fastening cam 58 is shown enlarged, and in isolation, in FIG. 3b. The diameter of the fastening cam 58 is only slightly smaller than that of the cam recess 56, so as to permit its insertion into the cam recess 56 via sliding through the side surface of the leg jamb 36, and to permit its rotation within the cam recess 56. The fastening cam 58 comprises a structure in its outer face that can be engaged by a driving tool to selectively rotate the fastening cam 58 while it is sitting in the cam recess 56. In this embodiment, the structure is a shaped indent 60, which can receive a correspondingly shaped driving end of driving tool (not shown) for rotating the fastening cam 58 as required. The fastening cam 58 further comprises an arced channel 62 formed from the internal walls 64, which spiral radially inward towards the axis of rotation of the fastening cam 58. The arced channel 62 is sized and shaped to receive the head 52 of the second portion 48 of a fastening post 40.

It will be appreciated that when the second portion 48 of the fastening post 40 is inserted into the cam bore 54 to a position at which the header jamb 22 abuts the leg jamb 28,30, the head 52 of the second portion 48 of the fastening post 40 extends into the arced channel 62 of the fastening cam 58 received by the cam recess 56. If the fastening cam 58 is rotated while the head 52 of the fastening post 40 is within the arced channel 62, the head 52 slidingly engages the camming surface of the internal walls 64. During rotation in one direction therefore, by virtue of the radially inward spiraling of the internal walls 64, the fastening post 40 will be pulled downwards, further through the cam bore 54. Thus, the header 22 and the first leg 28 have thereby been connected via the adjustable fastener and their abutment, now locked, may be progressively tightened through progressive rotation until an end of the arced channel 62 meets the fastening post 40.

The dimensions of the adjustable connector and the rest of the door framing system are selected to allow a tight connection between the header jamb 22 and the leg jambs 30, 36, before the fastening post 40 meets the end of the arced channel 62. This is so there is some room for adjustment to further tighten the connection should, through the lifetime of the door frame, adjustment be required.

Rotation of the fastening cam 58 in the opposite direction will progressively loosen the header 22 from the first leg 28, and eventually permit their disconnection.

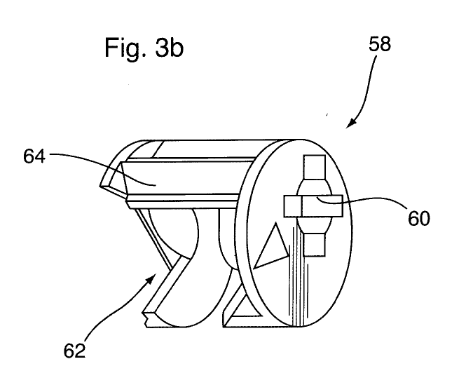

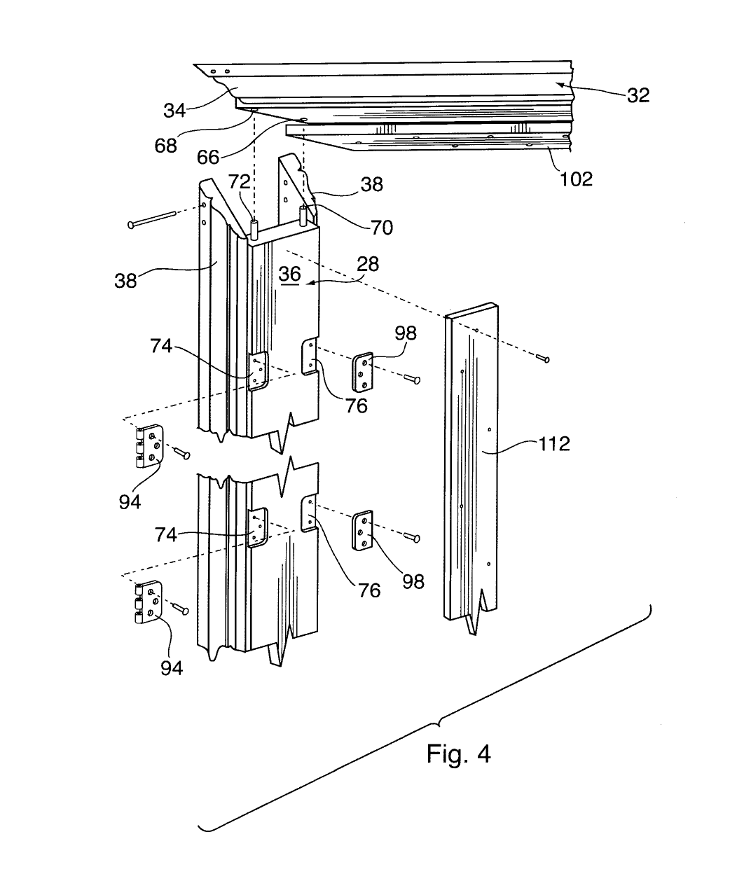

Reference is now made to FIGS. 4 and 5 showing an embodiment in which the ends of the header casings 34 are cut at approximately a forty-five degree angle such that the end of an upper surface of the header jamb 32 is flush with the end of the header casings 34. In this embodiment, the header jamb 32 further includes a pair of holes 66, 68. The holes 66, 68 in the header jamb 32 are laterally spaced from each other and are proximal the first end 24 of the header 22. In this embodiment these holes 66, 68 are 6.7 millimeters (0.264 inches) in diameter and extend right through the thickness of the header jamb 32. The second end 26 of the header 22 is the mirror image of the first end 24, with the ends of the casings 32 cut at substantially a forty-five degree angle.

Auxiliary posts, which in this embodiment are dowels 70, 72, are laterally spaced from each other and extend from the end of the leg jamb 36. The dowels 70, 72 are secured in the end of the leg jamb 36 by friction fit in two end holes formed in the leg jamb 36. The dowels 70, 72 extend from the center of the end of the leg jamb 36 instead of an edge to lessen the possibility of splitting in the end of the leg jamb 36. The ends of the leg casings 32 are also cut at approximately a forty-five degree angle and protrude from the end of the leg jamb 36. The leg casing ends abut the header casing ends at their forty-five degree angles.

The holes 66, 68 in the header 22 are appropriately dimensioned and positioned to align with and receive the dowels 70, 72 of the first leg 28 during assembly of the door framing system 20. In this embodiment, the dowels 70, 72 are 5.95 millimeters ( 15/64 inches) in diameter and the difference in diameter between the dowels 70, 72 and the holes 66, 68 is less than 0.80 millimeters ( 1/32 inch). Also, the header casings 24 and the leg casings 38 are cut at complementary angles (approximately forty-five degrees, as discussed above) in order to abut each other when the header 22 and the first leg 28 are connected. The above-described connection assists, in part, within the alignment of the header 22 with the legs 28, 30 of the door framing system.

It will be appreciated that the first leg 28 extends downwards so as to terminate at about a ninety-degree angle adjacent the floor of a building; when the door framing system 20 is assembled within a roughed-in doorway of the building, during construction or renovation.

In the respects described above, the second leg 30 is substantially the same as the first leg 28, but in the door framing system 20 is positioned to be a mirror image of the first leg 28. However, the first leg 28 differs from the second leg 30 in some respects, as will be described below.

The first leg 28 includes a first pair of hinge recesses 74 in a first side of the leg jamb 36 for attachment of hinges upon assembly with a door. In this embodiment, these hinge recesses 74 are precut using a router in a first side in the leg jamb 36 of the first leg 28 at positions corresponding to door hinge positions.

The first leg 28 also includes a second pair of hinge recesses 76 in a second side of the leg jamb 36 for attachment of hinges upon assembly with a door. Similar to the hinge recesses 74, the hinge recesses 76 in this embodiment are precut using a router in the second side in the leg jamb 36 of the first leg 28 at positions corresponding to door hinge positions.

In this embodiment, each of the first and second hinge recesses 74, 76, respectively, are routed to a depth of about one millimeter (1 mm) less than the thickness of the portion of the hinge that is to be inserted into the recess 74, 76.

As would be understood, the provision of both first hinge recesses 74 and second hinge recesses 76 enables hanging of a door that will swing outwards, or hanging of a door that will swing inwards.

Referring now to FIG. 5, the second leg 30 includes a first striker plate recess and a striker hole 78 on a first side of the second leg jamb 36. The first precut striker plate recess and striker hole 78 are positioned to correspond to the position of a striker along an edge of a door, to receive the striker when the door is being closed. The second leg 30 also includes a second precut striker plate recess and striker hole 80 on a second side of the leg jamb 36. Similar to the first precut striker plate recess and striker hole 78, the second precut striker plate recess and striker hole 80 are positioned to correspond to the position of a striker alone an edge of a door, to receive the striker when the door is being closed. It will be appreciated that the provision of both first and second striker place recesses and striker holes 78, 80 are provided in order to enable latching of a door to be hung either to swing outwards, or swing inwards.

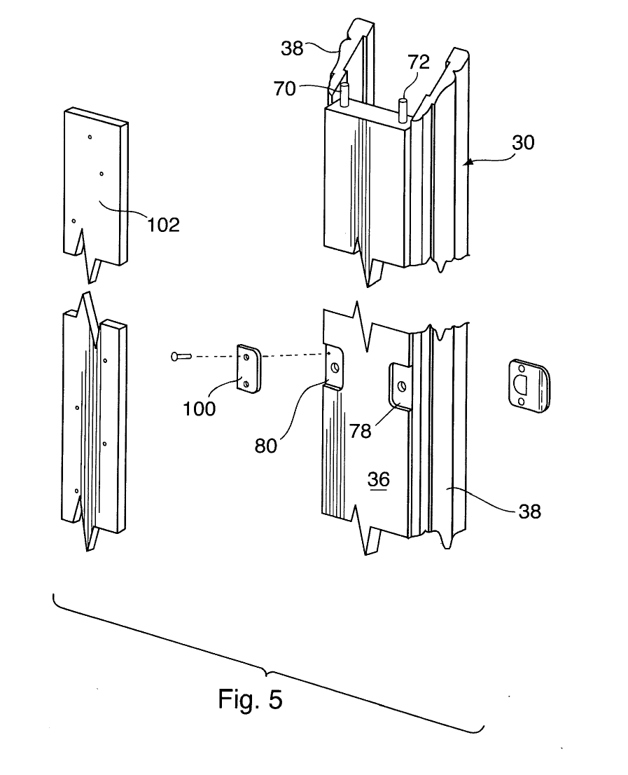

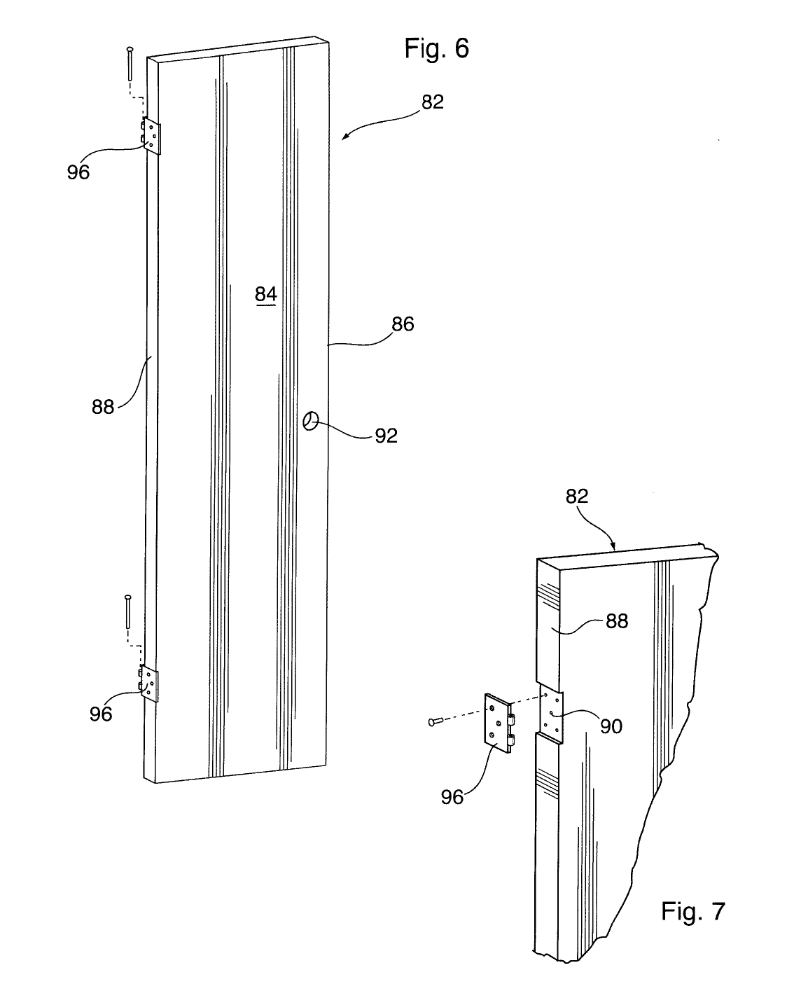

Turning now to FIGS. 6 and 7, there is shown a door 82 intended for hanging within the above-described door framing system 20. The door 82 includes a pair of sides 84, a front edge 86 and a rear edge 88. The rear edge 88 includes a pair of recessed hinge recesses 90 that extend through the width of the rear edge 88. In this embodiment, the recessed hinge placements 90 are routed to a depth of about one millimeter (1 mm) less than the thickness of the portion of the hinge that is to be received therein.

The front edge 86 is substantially normal (at substantially a ninety degree angle) to each of the sides 84. Similarly, the rear edge 88 is substantially normal to each of the sides 84.

The door 82 also includes its own striker hole 92 dimensioned and located in an appropriate position proximal the front edge 86 for receiving hardware for a doorknob or handle and the striker, latch etc.

In order to assemble the door framing system 20, each fastening post 40 is screwed into a corresponding hole 42 in the header jamb 32 until its shoulder 46 abuts against the surface of the header jamb 32. A fastening cam 58 is inserted into the cam recess 56 of the first leg 28 with the arced channel 62 being oriented to face the cam bore 54. The header 22 and first leg 28 are assembled for the roughed-in doorway by inserting the fastening post 40 into the cam bore 54 until the forty-five degree angle cuts in the header casings 34 meet the forty-five degree angle cuts in the leg casings 38. The forty-five degree angle cuts align and abut in this manner.

When the fastening post 40 is inserted into the cam bore 54, the head 52 of the fastening post 40 extends through the cam bore 54 into arced channel 62 of the fastening cam 58. As the fastening cam 58 is rotated, the head 52 is engaged by the internal walls 64 of the fastening cam 58, and slides along the internal walls 64. Due to the radially inward spiraling of the internal walls 64, the fastening post 40 is drawn downwards, further into cam bore 54. In this manner, the first leg 28 and the header 22 are connected and their corresponding outer. surfaces brought into contact and pulled progressively tighter together until a satisfactory tight connection is established.

It will be understood that the first leg 28 is assembled on the side of the roughed-in door frame on which it is desired that the door 82 is hinged. However, the second leg 30 is connected to the header 22 at its other end in a manner similar to that of the first leg 28.

In the above-described embodiment of the door framing system 20 where the first and second legs 28, 30 are also provided with respective dowels 70, 72 and the header jamb 32 is also provided with respective holes 66, 68 at each of its ends, during assembly the dowels 70, 72 are inserted into their respective holes 66, 68 prior to bringing the header jamb. 32 and the legs 28, 30 together into abutment.

Also during assembly, first hinge sides 94 are attached in hinge recesses 74 or 76 in the first leg 28. Which of the hinge recess pairs 74 or 76 will be used for hinge attachment depends upon whether the door is to open inwards, or to open outwards. In the embodiment shown in FIG. 4, the first hinge sides 94 are fixed within the first pair of hinge recesses 74 using screws. Because the hinge recesses 74 are routed to a depth that is about 1 min less than the thickness of the first hinge sides 94, the first hinge sides 94 protrude from the first pair of hinge recesses 74 by about 1 mm.

Second hinge sides 96 of the hinges are attached to the door 82 in respective hinge recesses 68 of the door 82, using screws. The second hinge sides 96 are attached to the door 82 so that the second hinge sides 96 correspond to the first hinge sides 94 to which they will be connected for opening and closing the door in the desired direction (i.e. inwards or outwards). As can be seen, in this embodiment, the second hinge sides 96 are rectangular in shape and substantially fill the entire hinge recesses 90. Because the hinge recesses 90 are routed to a depth that is about 1 mm less than the thickness of the second hinge sides 96, the second hinge sides 96 protrude from the first pair of hinge recesses 90 by about 1 mm.

Next, the door 82 is hung on the door frame, which includes aligning and enmeshing the first and second hinge sides 94, 96 and inserting hinge pins through both sides 94, 96 to couple them. A shim is then placed under the leg jamb 36 to level the door 82. Next, the leg casings 38 of the first leg 28 are fixed into place against the roughed in doorway by first nailing the leg casings 38 at a position near to the top one of the hinges and then nailing the leg casing 38 at a position near to the bottom one of the hinges.

As will be understood, the length of header 32 is a function of the width of door 82 in addition to the width of the two 1 mm hinge protrusions (eg. 2 mm). That is, the length of the header 32 is such that interference between the door 82, the slightly protruding hinges, and the assembled doorframe is avoided.

With the leg casings 38 having been fixed into place against the doorway, the header 32 is then pushed upward, away from the leg casings 38, in order to apply glue at the interface between the header 32 and the leg casings 38. It will be understood that the fastening cam 58 will have to remain at a position so as to not fully tighten the header jamb 32 against the leg jamb 36 in order to permit space to apply the glue.

With the glue having been applied, the header 32 is brought back against the leg casings 38 and the header casings 34 are nailed to the roughed in doorway at a position adjacent the forty-five degree angle cuts to keep the header casings 34 in place. The remainder of the door frame is then secured into place by nailing the second leg 30 into its corresponding position on the roughed in doorway. Preferably, the header casings 34 and leg casings 38 include pre-drilled holes through which the header casings 34 and leg casings 38 may easily be nailed or screwed to the roughed in doorway.

At this point, there will be unused hinge recesses in the first leg jamb and an unused striker plate recess and striker hole in the second leg jamb 36. As such, in an embodiment, fillers 98, also made of MDF, and shaped so as to fill each unused hinge recess, are provided. In this embodiment, the fillers 98 are held in place in respective unused hinge recesses using wood screws and/or glue. Furthermore, a cover 100 is provided for covering the precut but unused striker plate recess and striker hole. In this embodiment, the cover 100 is fixed in place using wood screws and/or glue.

In this embodiment, the door framing system 20 also comprises doorstop components 102 for applying over top of the header jamb 32 and leg jamb 36, respectively, after being affixed to the roughed in doorway. The doorstop components 102 are shown unattached in FIG. 1 and attached in FIG. 2. In this embodiment, the doorstop components 102 are of a width that is sufficient to cover a large portion of the fillers 98 and cover 100. The doorstop components 102 advantageously include predrilled holes through which the doorstop components 102 may be nailed to their respective header jamb 32 and leg jamb 36.

A significant advantage to the door framing system 20 described above is that it can be employed to hang a door 82 to open either inwards or outwards, and either with a right hand swing or a left hand swing. This great flexibility is useful because a purchaser of the door framing system 20 can choose the one type of door framing system, and simply assemble it according to the particular needs, rather than purchase multiple different door framing systems. The user would be required to know only the size of the door frame and the door that is to be used.

The many features and advantages of the invention are apparent from the detailed description and, thus, it is intended by the appended claims to cover features and advantages of the invention that fall within the true spirit and scope of the invention. Several modifications and variations may occur to those skilled in the art that would also fall within the scope of the claims.

For example, it will be understood that the sizes and shapes of several of the components of the door framing system 20 may be different from those described above, but will function, in respect of the present invention, in substantially the same way. For example, in an embodiment, the back surface of each of the header casings 34 and the leg casings 38 is concave. Also, while the header jamb 32 and the leg jamb 36 may be made of the same materials, such as MDF, components may be made of different materials.

The adjustable connector described above comprises a fastening post 40 and a fastening cam 58. Such adjustable fasteners, examples of which are Minifix™ connectors manufactured by Häfele or Quickfit™ connectors manufactured by Titus, are widely available commercially. However, it will be appreciated that other types of adjustable connectors/fasteners or combinations of such devices are contemplated so long as such alternatives function to permit tightening or loosening of the connections they facilitate, so as to permit adjustments over the lifetime of the resultant door frame. For example, a fastening post and fastening cam could be incorporated into a single integral unit, such as has been done in the Onefix™ one-piece connector manufactured by Häfele.

In the above-described embodiments, the first portion 42 of fastening post 40 is threaded and is screwed into the header 22. However, it will be appreciated that alternative configurations suitable for coupling the fastening post 40 to the header 22 may be used. For example, the first portion 42 of the fastening post 40 could be a spreading bolt having a harpoon thread for engaging the side wall of a pre-formed fastening bore. Alternatively, the first portion 42 could be a push-in-dowel having an expanding sleeve for engaging the side wall of a pre-formed fastening bore.

In the above-described embodiments the fastening bore 44 is proximal the end 24 of the header 22 and the cam bore 54 and cam recess 56 are at the end of leg jamb 36 of the first leg 28. Consequently, when the fastening post 40 secured to the header 22, the second portion 48 projects away from the end 24 of the header 22 towards and in alignment with the cam bore 54 of the first leg 28. However, in an alternative embodiment, the fastening bore 44 is positioned proximal the end of leg jamb 36 of the first leg 28 and the corresponding cam bore 54 is positioned proximal from the end 24 of the header 22. Therefore, when the fastening post 40 is secured to the end of leg jamb 36 of the first leg 28, the second portion 48 of the fastening post 40 projects away from the end of leg jamb 36 towards, and into alignment with, the cam bore 54 proximal from the end 24 of the header 22.

In the above-described embodiments, the door frame system 20 is assembled with two (2) adjustable fasteners (i.e. an adjustable fastener coupling the first end 24 with a first leg 28 and another adjustable fastener coupling the second end 26 with the second leg 30). However, it will be appreciated that more than two (2) adjustable fasteners may be provided if the header is to be wider, in order to provide increased connection strength and rigidity.

In an embodiment described above, the header jamb 32 comprises holes 66, 68. However, it will be appreciated that there may be just one (1) hole or more than two (2) holes at each end of the header and accordingly just one (1) complementary dowel or more than two (2) complementary dowels, respectively at the end of each leg.

The above is applicable to many different sizes and proportions of doorframes and doors. For taller doors, more than two hinge recesses can be routed on each side of the door jamb and thus, more than two corresponding hinge recesses can be routed at the rear edge of the door. For example, a taller door may be hung using three hinges rather than two.

The door frames, doors and hardware (such as the adjustable connector, screws, dowels, fillers, covers) can be packaged together for sale or can be sold as individually components.

When introducing elements disclosed herein, the articles “a”, “an”, “the”, and “said” are intended to mean that there are one or more of the elements. The terms “comprising”, “having”, “including” are intended to be open-ended such that there may be additional elements.

What is claimed is:

1. A door framing system comprising:
a header comprising a header jamb;
first and second legs each comprising a leg jamb dimensioned to abut against and extend downwards from a respective end of the header jamb; and
for each leg jamb, at least one adjustable connector for establishing a connection between the leg jamb and the header jamb and permitting selective tightening or loosening of the connection.

2. The door framing system of claim 1, wherein the header further comprises a pair of header casings along the header jamb.

3. The door framing system of claim 2, wherein the first and second legs each further comprise a pair of leg casings along its respective leg jamb.

4. The door framing system of claim 1, wherein each of the adjustable connectors comprises:
a fastening post having a first portion and a second portion, the first portion fastenable to one of either the header jamb or a leg jamb, the second portion extending away from the first portion;
a fastening cam dimensioned to engage the second portion, the fastening cam being rotatable within the other of either the header jamb and a leg jamb to permit selective pulling or releasing of the second portion thereby to tighten or loosen the connection.

5. The door framing system of claim 4, comprising one adjustable connector for each leg jamb.

6. The door framing system of claim 5, wherein each fastening post is fastened to a respective end of the header jamb, and each fastening cam is rotatably received within a respective leg jamb.

7. The door framing system of claim 6, wherein each leg jamb comprises a cam recess for receiving a respective fastening cam.

8. The door framing system of claim 7, wherein said fastening cam is rotatably mounted in said cam recess.

9. The door framing system of claim 8, wherein each leg jamb comprises a bore extending from an end of the leg jamb to the cam recess, each bore dimensioned to receive a respective second portion of a fastening post terminating at the fastening cam in the cam recess.

10. The door framing system of claim 4, wherein each fastening post comprises a head in its second portion for engaging the fastening cam.

11. The door framing system of claim 10, wherein each fastening cam comprises an arced channel about a portion of its circumference for receiving the head of a respective fastening post.

12. The door framing system of claim 10, wherein the arced channel comprises internal walls which spiral towards the rotation axis of the fastening cam to engage the head and, upon rotation, either progressively pull the header jamb towards the leg jamb thereby to tighten the connection, or progressively release the head thereby to loosen the connection.

13. The door framing system of claim 4, wherein said first portion comprises screw threads for screwing the first portion into one of either the header jamb or a leg jamb.

14. The door framing system of claim 13, wherein the fastening cam comprises a structure configured for engaging by a driving tool to selectively rotate the fastening cam.

15. The door framing system of claim 14, further comprising at least one auxiliary post extending from either the header jamb or a leg jamb, and at least one hole in the other of either the header jamb or the leg jamb for receiving a respective auxiliary post in interference fit.

16. The door framing system of claim 1, further comprising:
at least two hinge recesses on the first leg jamb; and
at least one each of a striker plate recess and a striker hole on the second leg jamb,
wherein the hinge recesses, striker plate recesses and striker holes accommodate mounting of a hinged door within the door framing system in either of two ways.

17. The door framing system of claim 16, wherein the at least two hinge recesses comprises two hinge recesses on a first side of the first leg jamb, and two hinge recesses on a second side of the first leg jamb, and the at least one each of the striker plate recess and the striker hole comprises a striker plate recess and striker hole on a first side of the second leg jamb and a striker plate recess and striker hole on a second side of the second leg jamb.

18. The door framing system according to claim 17, further comprising a filler for filling in hinge recesses that are not to be used.

19. The door framing system according to claim 17, further comprising a cover for covering a striker plate recess and striker hole that are not to be used

20. The door framing system according to claim 3, wherein the leg casings and the header casings are dimensioned to abut at about a forty-five degree angle.
